(19) United States
(12) Patent Application Publication
(10) Pub. No.: US 2026/0127683 A1
(43) Pub. Date: May 7, 2026

(54) GAP CHECKS

(71) Applicant: SAP SE, Walldorf (DE)

(72) Inventor: Oliver Grob, Illingen (DE)

(21) Appl. No.: 18/936,630

(22) Filed: Nov. 4, 2024

(51) Int. Cl. G06Q 40/12; G06F 16/23; G06Q 20/20

(52) U.S. Cl. CPC G06Q 40/12; G06F 16/2358; G06Q 20/202

(57) ABSTRACT

Systems, methods, and articles of manufacture, including computer program products, are provided including receiving one or more records; storing the received one or more records in a store further including a plurality of records; retrieving at least a first record; checking the first record for a unique identifier, wherein the unique identifier comprises a previous identifier associated with a previous record and a current identifier associated with the first record; in response to detecting the previous identifier, searching for at least one other record that contains the previous identifier as a current identifier; in response to the searching indicating a gap, sending a message to a server to provide at least one missing record associated with the gap; in response to the searching indicating the gap is not present, flagging the first record as audited; and passing the first record to a first system.

### BACKGROUND

The phrase “Enterprise Resource Planning” or “ERP” refers to a system that integrates processes for an enterprise, such as a business or other type of organization. The ERP system enables the enterprise to manage enterprise functions, such as human resources, purchasing, supply chain management, travel, inventory management, financial control and/or reporting, customer relationship management, and the like. The ERP system may include a database, analytics, reporting, security, and/or other functions.

For example, the database may be configured to store an organized collection of data for the enterprise. To illustrate further, data may be stored in a relational according to a schema defining one or more relations, each of which being a set of tuples sharing one or more common attributes. The tuples of a relation may occupy the rows of a database table while the columns of the database table may store the values of the common attributes shared by the tuples. Moreover, one or more attributes may serve as keys that establish and identify relationships between the relations occupying different database tables. The database may support a variety of database operations for accessing the data stored in the database. For instance, the database may support transactional processing (e.g., on-line transactional processing (OLTP)) that modifies the data stored in the database. Alternatively, and/or additionally, the database may support analytical processing (e.g., on-line analytical processing (OLAP)) that evaluates the data stored in the database.

### SUMMARY

Systems, methods, and articles of manufacture, including computer program products, are provided including receiving one or more records; storing the received one or more records in a store further including a plurality of records; retrieving at least a first record; checking the first record for a unique identifier, wherein the unique identifier comprises a previous identifier associated with a previous record and a current identifier associated with the first record; in response to detecting the previous identifier, searching for at least one other record that contains the previous identifier as a current identifier; in response to the searching indicating a gap, sending a message to a server to provide at least one missing record associated with the gap; in response to the searching indicating the gap is not present, flagging the first record as audited; and passing the first record to a first system.

In some variations, one or more features disclosed herein including one or more of the following features may be implemented as well. The one or more records, the plurality of records, the first record, and the other record comprise point-of-service transaction records. The first system comprises an enterprise resource planning system. The one or more records are received by an audit system coupled to the first system, and wherein the one or more records are received from a point-of-service device. The store is located at the audit system, and wherein the store contains the plurality of records that have not been audited by the audit system. The audit system retrieves the first record from the store. A duplicate check is performed for at least the first record by at least searching for another record that contains the current identifier associated with the first record. Moreover, in response to the searching for the other record that contains the current identifier associated with the first record not detecting any duplication records, flagging first record as audited. The previous identifier and the current identifier may each comprise a 128-bit value configured to provide a universally unique identifier. The previous identifier and the current identifier may each comprise a date, a time, a media-access control (MAC) address, and/or a random value.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable storage medium or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an example of a system diagram including an audit system, in accordance with some implementations;

FIG. 2 depicts an example of a point of sale (POS) transaction record including an error, in accordance with some implementations;

FIGS. 3A, 3B, 3C, 3D, and 3E depict various examples of POS transaction records, in accordance with some implementations;

FIG. 4A depicts an example of an audit process for checking for gaps in POS transaction records, in accordance with some implementations;

FIG. 4B depicts an example of an audit process for checking for duplicates in POS transaction records, in accordance with some implementations;

FIG. 5A depicts a block diagram illustrating an example of a computing system, in accordance with some implementations; and

FIG. 5B depicts a block diagram illustrating another example of a computing system using virtual machines for cloud implementations, in accordance with some implementations.

When practical, similar reference numbers denote similar structures, features, or elements.

### DETAILED DESCRIPTION

When transferring POS transactions from a POS device, such as a POS register, a POS laptop, or other processor-based POS device, to a system (e.g., an enterprise resource planning (ERP) system), there may be one or more errors that may occur for a variety or reasons, such as data entry errors, coding errors, human error, software errors, and so forth. An audit system may be used to check the POS transactions for errors and correct the errors before passing the POS transactions to the ERP system.

Each POS transaction may be assigned a POS transaction identifier (or transaction ID, for short). The transaction identifier may comprise a value or counter value that is incremented after each transaction. In this way, an audit system may determine whether there are any gaps in the POS transaction records. Given for example a sequence of POS transactions with transaction identifiers of 1001, 1002, 1013, 1014, for example, the audit system may flag (i.e., identify) that there is a possible gap (as, e.g., there is a gap between 1002 and 1013), in which case the audit system may request the POS device to resend the POS transactions to the audit system.

Moreover, the POS transaction record's transaction identifiers may be reset to a new start value from time to time. For a given retailer for example, the transaction identifiers may be reset each day, so the transaction identifiers may for example start at 0000 each day and increment by one for each POS transaction. Furthermore, for a given retailer, each location (e.g., each store) may use the same or similar set of transaction identifiers, so the transaction identifiers may not be unique across locations. As such, the audit system may consider date and location (e.g., store ID) of the POS transaction identifiers when looking for gaps in the POS transactions. These subtleties can cause issues when the audit system audits POS transactions for a retailer having for example a number of store locations. Another issue with the transaction identifiers is the duplicate check, which must ensure that transactions are not transferred multiple times. The check is also done on the transaction identifiers, so the same issues apply here.

Rather than use POS transaction identifiers having a simple sequence of numbers (e.g., the incremental, one-up per POS transaction noted above), a unique identifier (ID) may be used for each POS transaction record. The unique ID may be unique for all POS transactions, so the unique ID would not be used twice over time or across stores of the same retailer. The unique identifier may be generated (or, e.g., managed) by a central server associated with the POS system. The UID may, as noted, be unique at least over time (or at least a given period, such as month, quarter, year, etc.) and across an entity's (e.g., a retailer's) POS devices.

In some embodiments, the UID may be universally unique ID (UUID). In the case of a universally unique ID, the transaction ID is unique over time and across entities, such as some if not all retailers. For example, the UUID may comprise a 128-bit value and may be in accordance with a standard, such as RFC 9562 (“Universally Unique Identifiers (UUIDs)”, May 2024). Alternatively, or additionally, the UUID may formed as a combination of one or more of the following: the date, the time (e.g., UTC time), the media-access control (MAC) address of the POS device, a random value, and/or other values. Moreover, the UUID may formed as a hash of a combination of one or more of the following: the date, the time (e.g., UTC time), the media-access control (MAC) address of the POS device, a random value, and/or other values a hash may be performed on the combination.

In some embodiments, the unique ID for the POS transaction record comprises a chain of a plurality of identifiers.

In some embodiments, the unique ID for the transaction record comprises a chain of a first transaction ID and a second transaction ID.

In some embodiments, the chain comprises a chain of a first UUID for a previous POS transaction record and a second UUID for a current POS transaction record.

Before providing additional description regarding the POS transaction's unique ID comprising a chain of identifiers, the following describes an example system environment.

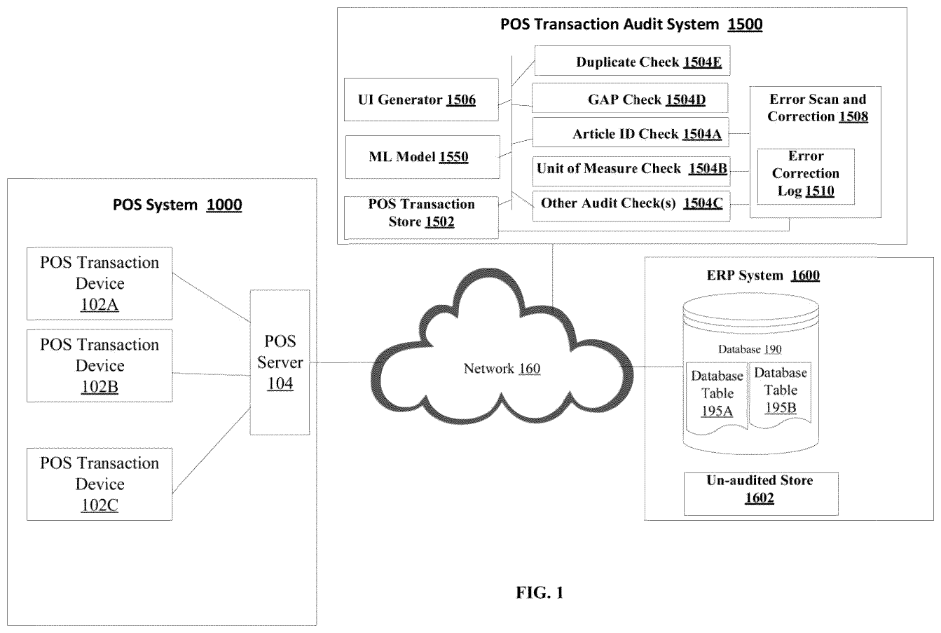

FIG. 1 depicts an example of a system 100 including a POS system 1000 (which further includes a plurality of POS transaction devices 102A-C and a POS server 104), an audit system 1500, and an ERP system 1600, all of which may be coupled via a network 160. The network 160 may be a wired network and/or wireless network including, for example, a public land mobile network (PLMN), a local area network (LAN), a virtual local area network (VLAN), a wide area network (WAN), the Internet, and/or the like.

The POS transaction devices 102A-C may comprise a processor-based system including memory and a network interface. The POS transaction devices may comprise or be comprised in a mobile device, a wearable apparatus, a personal computer, a workstation, a tablet computer, an Internet-of-Things (IoT) appliance, and/or the like. When a transaction occurs at a POS transaction device (e.g., POS register or terminal such as the POS transaction device 102A), a user may for example scan an item as part of a purchase of the item. When the item is purchased, the POS transaction device may then generate a POS transaction record listing at least the item as well as other data associated with the item.

The POS system 1000 may include a POS server 104. The POS server 104 may control one or more aspects of the POS transaction devices. For example, the POS server 104 may aggregate the POS transactions before providing the POS transactions to the audit system 1500, ERP system 1500, a cloud object store, and/or the like. Moreover, the POS server 104 may assign or manage each POS device's transaction's unique ID. For example, the POS server may instruct or provide each of the POS systems to use a UUID format (e.g., POS device MAC address plus date-time or hash of POS Device MAC address plus date-time).

Although the POS server 104 is depicted within the POS system 1000, the POS server 104 may be implemented as part of other systems as well (e.g., the audit system 1500, ERP system 1600, and/or other systems).

A POS transaction device, such as POS transaction device 102A, may send (which may be via POS server 104) one or more POS transaction records to a POS transaction store 1502 (e.g., a cache, a database, an object store, etc.) at an audit system 1500 (labeled “POS Transaction Audit System) while waiting for the audit system 1500 to perform one or more audit checks on the POS transaction records. Alternatively, or additionally, the POS transaction records may be sent (which may be via POS server 104) to the ERP system 1600, where the POS transaction records are held in an un-audited store 1602 (e.g., a database, an object store, etc.) while waiting for the audit system 1500 to perform one or more audit checks on the POS transactions.

The ERP system 1600 may include for example analytical tools including query tools, ERP functions, and one or more databases, such as a database 190. Moreover, at least a portion (if not all) of the POS transaction records may be stored at the database 190 in one or more database tables 195A-B. Alternatively, or additionally, at least a portion (if not all) of the POS transaction data may be stored in an object store. For example, after the POS transaction records are audited (and/or corrected) by the audit system 1500, the POS transaction records may be stored at the database 190 (or as noted an object store) to enable use by the ERP system 1600.

The one or more databases such as the database 190 may comprise one or more relational database technologies including, for example, an in-memory database, a column-based database, a row-based database, a hybrid database (e.g., combination of column and row based), and/or the like. Alternatively, or additionally, the ERP system may include or be coupled to an object store, such as a cloud object store. In the case of that the database 190 comprises an in-memory relational database system, the in-memory relational database may utilize main memory (“in-memory”) for the primary storage of database tables. For example, the in-memory relational database may be implemented as a column-oriented database (or a columnar database) that stores data from database tables by columns instead of by rows. In the case of the in-memory column-oriented relational database for example, each tuple of a relation may correspond to a record occupying one row of a database table while the columns of the database table may store the values of the common attributes shared by multiple tuples, such that the values occupying each column of the database table (which may span multiple rows (or records) of the database table) may be stored sequentially in one or more data pages, with each data page storing at least a portion of a column. The in-memory column-oriented relational database may support efficient data compression and partitioning for massively parallel processing. Because the in-memory database is directly accessible by the central processing unit (CPU) of the computing engine, transactions accessing the in-memory database may be executed to provide near-instantaneous results. Alternatively, or additionally, at least a portion (if not all) of the POS transaction data may be stored in an object store.

Although the some of the examples refer to the un-audited POS transaction records being stored at the POS transaction store 1502 and/or the un-audited store 1602, the un-audited POS transaction records may be stored in other locations as well (e.g., object store, database, data lake, etc.) while waiting for processing (e.g., auditing, etc.) by the audit system 1500.

Although FIG. 1 depicts a certain quantity of POS transaction devices, audit system, and ERP system, other quantities and/or configurations of the POS transaction devices, audit system, and ERP system may be implemented as well.

In some embodiments, the audit system 1500 may retrieve one or more of the POS transaction records stored in the POS transaction store 1502. The audit system 1500 may then use the retrieved POS transaction records to perform one or more audit checks, such as an article ID check 1504A (which checks for errors in the article ID of the POS transaction record), a unit of measure check 1504B (which checks for errors in the unit of measure checks of the POS transaction record), and/or other audit checks 1504C. Other audit checks 1504C of the POS transaction may be performed as well. Examples of the other audit checks include duplicate checks (which searches for duplicate transactions that have been transmitted by a POS device more than once).

In some embodiments, the audit system 1500 may include a GAP check 1504D. For example, the gap check 1504D detects whether there are gaps in the POS transaction records, wherein a gap indicates at least one missing POS transaction record.

In some embodiments, the audit system 1500 includes a Duplicate check 1504E For example, the duplicate check 1504E detects whether there are duplicates (e.g., multiple copies) of the same POS transaction record.

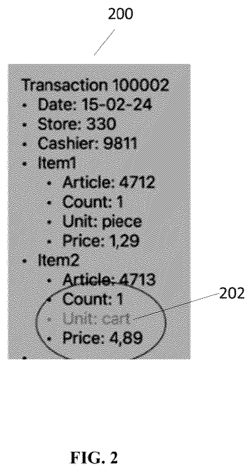

FIG. 2 depicts an example of a POS transaction record 200 generated by for example a POS transaction device, such as the POS transaction device 102A. For example, the POS transaction record 200 may include a Transaction Record Identifier (ID), which in this example is “100002” (which is a unique identifier for the transaction). Moreover, the POS transaction record may include one or more of the following: a date of the transaction (e.g., 15 Feb. 2024”); a store identifier (e.g., Store: 330); a cashier identifier (e.g., Cashier: 9811), and/or other information associated with the transaction. Furthermore, the POS transaction record 200 may include one or more item descriptions (e.g., “ITEM1”). The item description refers to the item that is the subject of the transaction and thus being sold via the POS transaction device. The item description may further include one or more of the following: an article ID (e.g., 4712 which uniquely identifies the item and may be mapped to the bar code or UPC code of the item); a count (e.g., a quantity of items being sold); a unit that refers to the units of measure (which in this example, is “1” item; but may be in other forms, such as dozen, cartoon, box, etc.); and item price (e.g., 1,29). In the example of FIG. 2, the POS transaction record 200 includes a second item, “Item2.” In the example of FIG. 2, the POS transaction record 200 includes an example of an error 202 in the unit. Specifically, the unit “cart” (e.g., carton) is flagged as a unit of measure error (e.g., by the audit system). The mistake unit of measure error of “cart” at error 202 may be detected in a variety of ways. For example, the unit of measure check 1504B and/or the ML model 1550 may detect an error, which in this example is a unit of measure error of “cart” (e.g., error 202). Alternatively, or additionally, the UI generator 1506 may present a POS transaction records for audit on a UI presented to a user such as an auditor, where a selection can be used to indicate or flag the error.

Additional examples of POS transaction errors include the following. The POS transaction record may include an incorrect (e.g., errored, wrong, mistaken, etc.) article ID which identifies the item or article that is sold via the POS transaction. Alternatively, or additionally, the POS transaction record may include an error in the unit of measure. For example, the unit of measure may indicate a quantity of the items in the transaction (e.g., a single item, a dozen items, a box of 12, a case of 24, etc.). In the example of FIG. 2, the unit of measure is detected as an error when an audit check is performed on the unit of measure. Alternatively, or additionally, the POS transaction record may include an incorrect store identifier, incorrect date, invalid address, invalid telephone number, invalid loyalty number, etc. Some of the POS transaction record errors may be caused by for example a mistake at the POS device where the transaction is made. For example, a scanning error of the product or the system lacking correct data mapping the bar code to the unit of measure for example. Nonetheless, the audit system 1500 may be used to detects errors and/or correct the error in a POS transaction record.

Referring again to FIG. 2 at the Transaction Record Identifier (ID) “100002”, as noted above, this identifier for the POS transaction record 200 may not be unique across a plurality of entities (e.g., a plurality of stores each with their own store ID) and/or across time (e.g., where the identifier is reset every day at midnight for example). As such, the identifier depicted at FIG. 2 may cause issues during audits with respect to gap checking and/or duplicate checking.

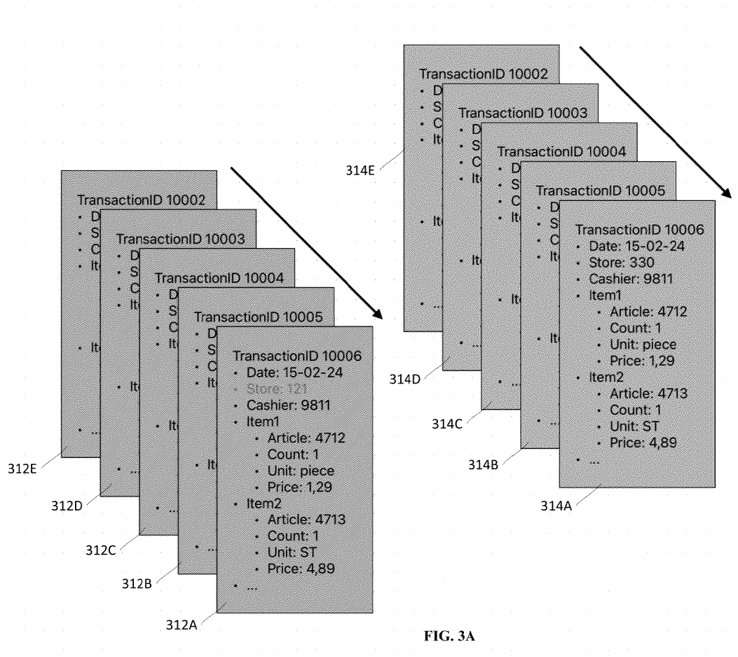

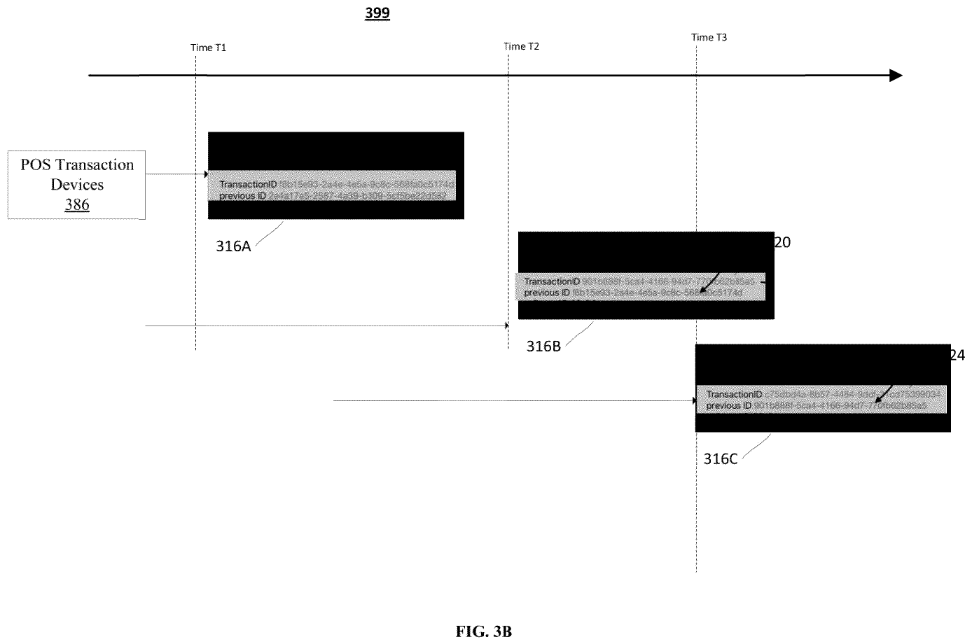

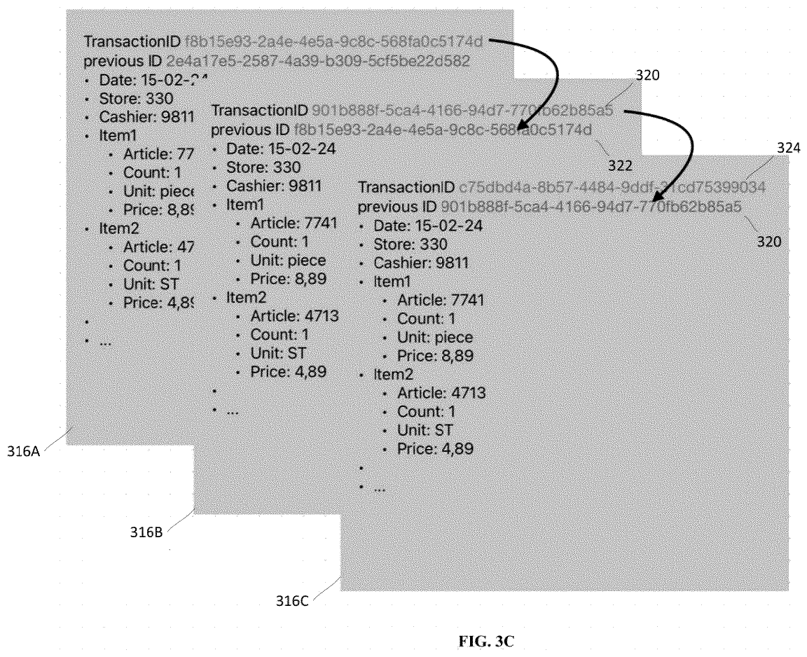

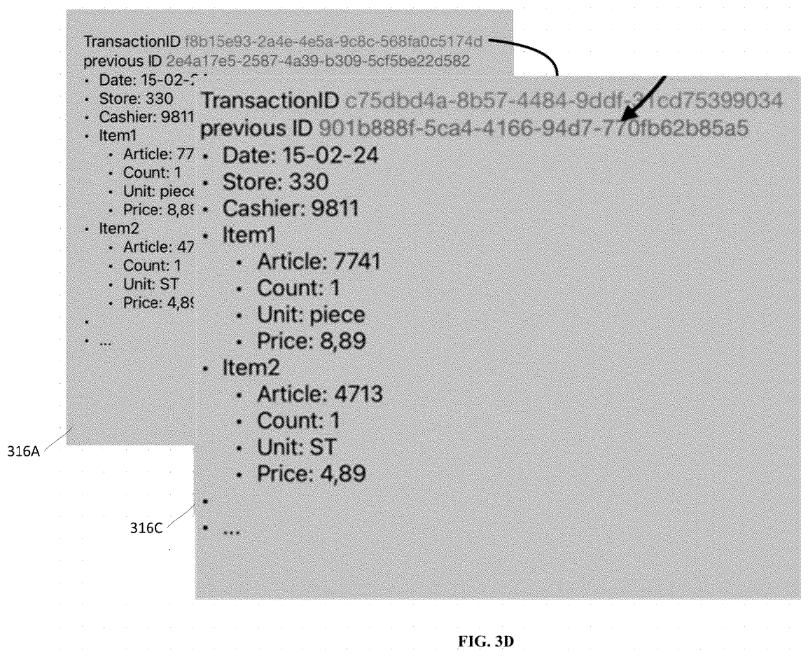

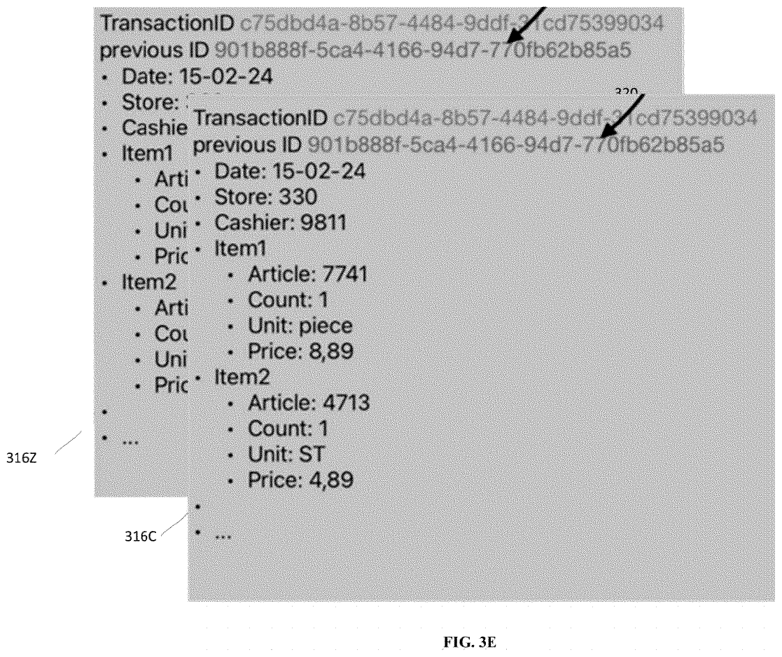

FIG. 3A depicts a first set of POS transaction records 312A-E. In this example, the first set of POS transaction records 312A-E all originate from a first store (e.g., store ID 121) and on the same date (e.g., “15 Feb. 2024”). Like the example of FIG. 2, the transaction IDs for the first set of transaction records follow the sequence 10002, 10003, 10004, 10005, and 10006. FIG. 3A also depicts a second set of POS transaction records 314A-E. In this example, the second set of POS transaction records 314A-E all originate from a second store (e.g., store ID 330), which is different from the first store associated with the first set of POS transaction records 312A-E and on the same date (e.g., “15 Feb. 2024”). When the audit system 1500 and, in particular, the gap check 1504D performs gap checks and the duplicate check 1504E checks for duplicates, the audit system in this example needs to load into memory a large quantity of POS transaction records and also consider the date/time and store IDs. As such, the audit checks are complex and require additional resources (e.g., memory and processor capability) to cross reference all of the different POS transaction records in the first set and the second set.

In some embodiments, a POS transaction record may include a unique ID. Alternatively, the unique ID may comprise a universally unique ID (UUID).

In some embodiments, the unique ID comprises a current POS transaction ID and a prior POS transaction ID. The current POS transaction ID refers to the “current” POS transaction record which is the subject of the POS transaction and thus includes the details of the transaction, such as the items of the POS transaction and the like. The prior POS transaction ID refers to a POS transaction record that occurs right before the current POS transaction.

For example, each POS transaction may be numbered with a POS transaction ID that can be used to identify the transaction. For example, the POS transaction ID may be a sequential count (e.g., 0, 1, 2, etc.) for each POS transaction at a given location and/or a UUID generated by the system so that it is universally unique.

FIG. 3B depicts an example timeline 399 of POS transaction records 316A-C. At time T1, one of the POS transaction devices 386 sends a POS transaction record 316A, at time T2, one of the POS transaction devices 386 sends a POS transaction record 316B, and at time T3, one of the POS transaction devices 386 sends a POS transaction record 316C. Referring to POS transaction record 316C for example, at time T3, this POS transaction record 316C may be considered the current transaction record ID 324, while the prior POS transaction ID 320 corresponds or maps to the prior POS transaction record 316B.

FIG. 3C depicts an example of the POS transaction records 316A-C. In the example of FIG. 3C, the unique ID for the POS transaction record comprises a previous transaction ID 322 and a current transaction ID 320. The previous transaction ID 322 represents a transaction ID for the POS transaction records 316A occurring right before the POS transaction record 316B. In other words, the POS transaction record 316B has (e.g., is assigned, is mapped to, includes) a unique transaction ID comprising a chain of the prior transaction ID 322 and a current transaction ID 320. The use of the chain of transaction ID may enable the audit system 1500 to detect gaps in the POS transaction more efficiently. Moreover, in the example of FIGS. 3B and 3C, the unique transaction IDs may comprise universally unique IDs (UUIDs), which may be generated as noted herein.

During audit by the auditing system 1500, the gap check 1504D may for example obtain the POS transaction record 316A and POS transaction record 316C but not POS transaction record 316B. In this example, the gap check 1504D detects, in response to receipt of POS transaction record 316C, a gap as the audit system and in particular missing POS transaction record 316B. Specifically, the gap check 1504D may evaluate the POS transaction record's 316C chain current transaction ID 324 (“c75db . . . ”) and the previous transaction ID (“901b88 . . . ”) 320 to detect (e.g., identify, determine, etc.) a gap in the POS transaction records caused by the missing POS transaction record 316B. In other words, the gap check 1504D can detect a gap using only two POS transaction records, rather than accessing a larger quantity of POS transaction records (and sorting by date and/or storeID) to detect a gap. Nor does the audit system 1500 have to consider resets of IDs (e.g., daily midnight resets).

Moreover, when a first UUID is used for the previous transaction ID 320 and a second UUID is used as the current transaction ID 324, the gap can be detected without loading (e.g., into memory and checking) across other stores and/or time periods. Alternatively, the use of the UUIDs may enable the duplicate check 1504E to detect duplicates more efficiently as the POS transaction records from other stores and/or dates are not needed to detect the duplicates. In the case of the UUID, a gap may be detected just by for example searching for the UUID which is unique across for example multiple locations.

In some embodiments, a ML model 1550 may process the POS transaction records. The ML model 1550 may detect (and/or identify) candidate POS transaction records that might have an error, such as article ID, unit of measure, and/or other errors. Alternatively, or additionally, one or more POS transaction records (which may be un-audited or candidate POS transaction records with possible errors) may be presented as one or more views on a user interface (e.g., the UI generator 1506 generates a UI including one or more of the candidate, errored POS transaction records). At the UI, a user selection can be used to confirm whether the detected or possible error is truly an error (or not an error). Once confirmed, the error may be corrected with the correction, and the corrected POS transaction record may be passed as an audited POS transaction record to the ERP system for storage and/or processing. In some instances, the corrected POS transaction record may undergo additional audit checks by the audit system 1500 before passing to the ERP system. Alternatively, or additionally, the confirmation at the UI may be used to further train the ML model 1550. For example, the ML model 1550 may comprise a convolutional neural network (CNN), a Recurrent Neural Network (RNN), a LSTM (long short-term memory), and/or a combination of the three. And, the ML model 1550 may be trained using among other things reference data (e.g., POS transactions with errors, POS transaction without errors, as well as confirmed POS transaction records with or without errors). For example, machine learning may be used to track corrections which are done by auditors via a UI. If there is a pattern of corrections that are performed, the ML model may learn the pattern and propose corrections automatically to the auditor/audit system or even do implement the corrections autonomous.

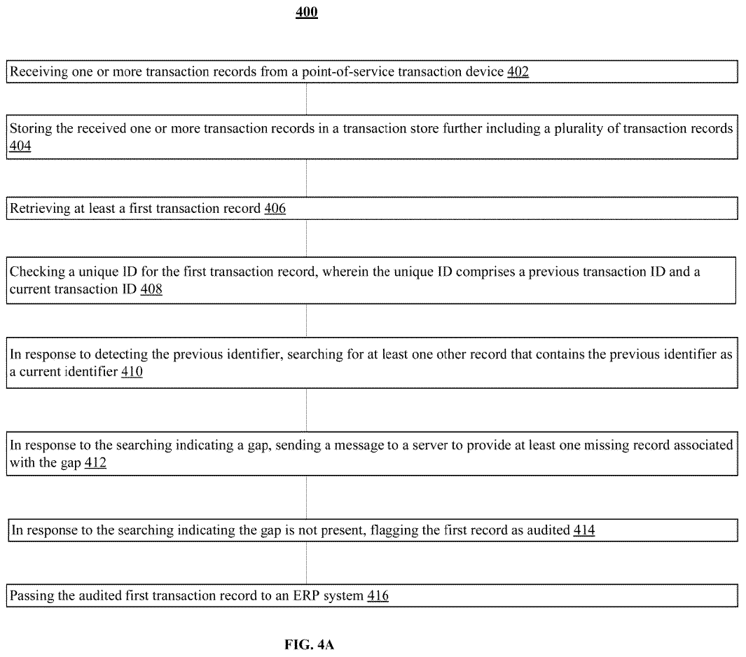

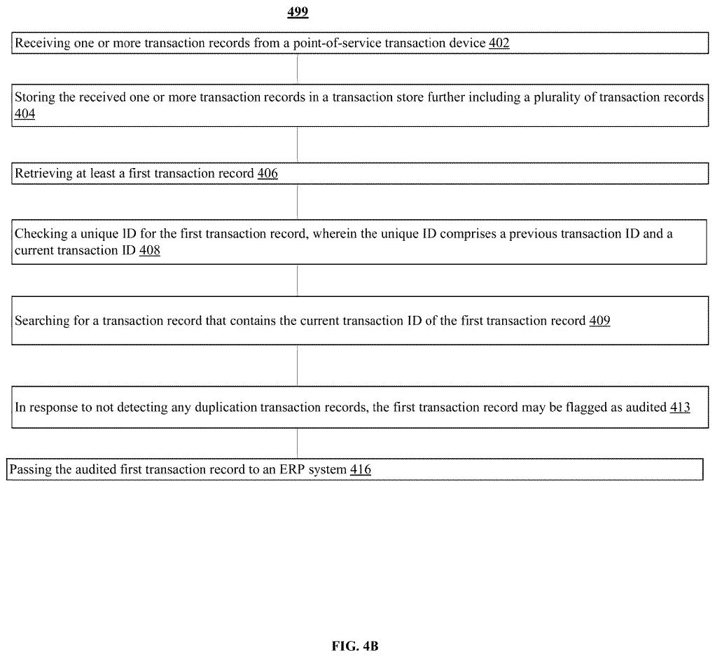

FIG. 4A depicts a flowchart illustrating an example of a process 400 for auditing POS transaction records, in accordance with some implementations. The process 400 may be used to provide a computer-implemented method and/or a non-transitory computer-readable medium.

At 402, the process 400 may include receiving one or more transaction records from a point-of-service transaction device, in accordance with some embodiments. Referring to FIGS. 1 and 2 for example, one or more transaction records, such as POS transaction record 200, may be generated by for example a POS transaction device. When this is the case, the POS transaction device, such as POS transaction device 102A, may send the POS transaction record. The POS transaction record may be sent to (and thus received by) the audit system 1500 (e.g., POS transaction store 1502), ERP system 1600 (e.g., un-audited store 1602), and/or to other locations.

At 404, the process 400 may include storing the received one or more transaction records in a transaction store further including a plurality of transaction records, in accordance with some embodiments. Referring to FIGS. 1-3C for example, the received POS transaction records may be stored at the audit system 1500 at for example the POS transaction store 1502. Alternatively, or additionally, the received POS transaction records may be stored at the ERP system 1600 and, in particular, at the un-audited store 1602. Although the previous examples refer to storing the received POS transaction records in the POS transaction store 1502 and/or the un-audited store 1602, the received POS transaction records may be stored at other locations as well (e.g., a cloud-based object store, data lake, etc.) At 406, the process 400 may include retrieving at least a first transaction record, in accordance with some embodiments. Referring to FIG. 1 for example, when the audit system begins an audit of the POS transaction records, the POS transaction records may be retrieved from the storage as noted at 404 for processing of the one or more checks, such as article ID check 1504A, unit of measure check 1504B, gap check 1504D, and/or duplicate check 1504E.

At 408, the process 400 may include checking a unique ID for the first transaction record, wherein the unique ID comprises a previous transaction ID and a current transaction ID. Referring to FIG. 1 and FIG. 3C for example, the audit system may check the POS transaction record's 316C previous transaction ID 320 and the current transaction ID 324. As noted, the previous transaction ID 322 and the current transaction ID 320 may each comprise a UUID.

At 410, the process 400 may include in response to detecting the previous transaction identifier, the audit system may search for at least one other POS transaction record that contains the previous transaction ID as a current transaction ID. Referring to FIG. 1 and FIG. 3C for example, the audit system may check the POS transaction store 1502, un-audited store 1602, object store, or cache for any POS transaction records that contain the previous transaction ID 320 (“901b88 . . . ”) as a current transaction ID. Referring to FIG. 3C, the search would identify POS transaction record 316B (which includes as the current transaction ID 320 “901b88 . . . ”), so there is no gap. Referring to FIG. 3D, the search would identify a gap since a search for a POS transaction record with a current transaction ID of “901b88 . . . ”) would reveal there is no such record and thus a gap in the POS transactions.

At 412, the process 400 may include in response to the searching indicating a gap, sending a message to a server to provide at least one missing record associated with the gap. For example, audit system 1500 may send a message to the POS server 104 to provide a copy of the missing POS transaction record corresponding to the gap, such as the gap caused by missing current transaction ID “901b88 . . . ”. When the POS server 104 provides the missing POS transaction record, the missing POS transaction record may be processed as noted with respect to process 400 and in particular 408 and so forth.

At 414, the process 400 may include in response to the searching indicating the gap is not present, flagging the first record as audited. Referring to FIGS. 1 and 3C for example, the audit system may flag that the first transaction record 316C and the previous transaction record 316A as audited or at least as not having a gap.

At 416, the process 400 may include passing the audited first transaction record to an ERP system, in accordance with some embodiments. As the first POS transaction record has been audited at least for the gap check (if not other types of checks), this POS transaction record may be considered audited and then passed by the audit system 1500 to the ERP system 1600 for use in ERP analytics and the like.

FIG. 4B depicts another example of a process 499 for auditing POS transaction records, in accordance with some implementations. The process 499 may be used to provide a computer-implemented method and/or a non-transitory computer-readable medium.

At 402, the process 499 may include receiving one or more transaction records from a point-of-service transaction device, in accordance with some embodiments. This may be performed in the same or similar way as noted above with respect to FIG. 4A.

At 404, the process 499 may include storing the received one or more transaction records in a transaction store further including a plurality of transaction records, in accordance with some embodiments. This may be performed in the same or similar way as noted above with respect to FIG. 4A.

At 406, the process 499 may include retrieving at least a first transaction record, in accordance with some embodiments. This may be performed in the same or similar way as noted above with respect to FIG. 4A.

At 408, the process 499 may include checking a unique ID for the first transaction record, wherein the unique ID comprises a previous transaction ID and a current transaction ID. This may be performed in the same or similar way as noted above with respect to FIG. 4A.

At 409, the process 499 may include searching for a transaction record that contains the current transaction ID of the first record. Referring to FIG. 1 and FIG. 3C for example, the audit system may check the POS transaction store 1502, un-audited store 1602, object store, or cache for any POS transaction records that contain the current transaction ID (e.g., “c75db . . . ”) for the POS transaction record 316C. This check may be performed by the duplicate check 1504E of the audit system 1500.

At 411, the process 499 may include in response to identifying at least one duplicate transaction record having a same current transaction ID as the first transaction record, marking the at least one duplicate transaction record for deletion. Referring to FIGS. 1 and 3E, the audit system may find at least one duplicate POS transaction record 316Z which has the same current transaction ID as FIG. 3C.

At 413, the process 499 may include in response to not detecting any duplication transaction records, the first transaction record may be flagged as audited. Referring to FIG. 1 and FIG. 3C for example, the audit system may flag at least the first transaction record 316C as not having any duplicate POS transaction records.

At 416, the process 400 may include passing the audited first transaction record to an ERP system, in accordance with some embodiments. This may be performed in the same or similar way as noted above with respect to FIG. 4A.

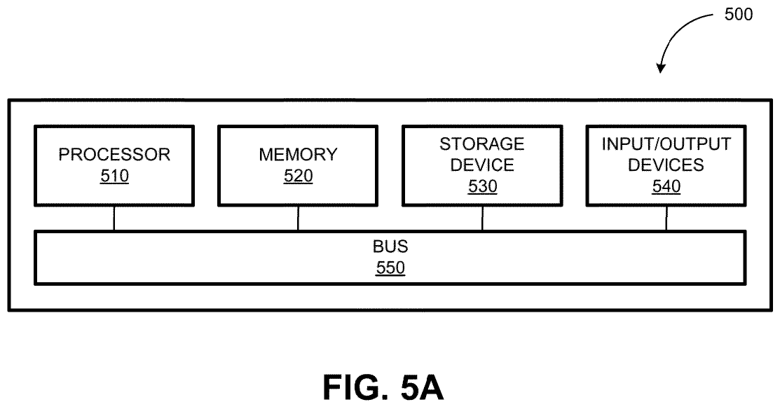

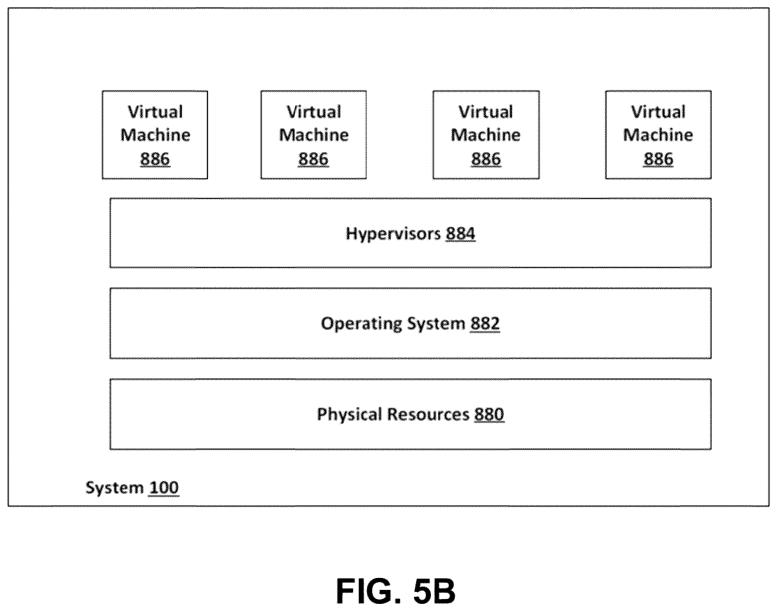

As shown in FIG. 5A, the computing system 500 can include a processor 510, a memory 520, a storage device 530, and input/output device 540. The processor 510, the memory 520, the storage device 530, and the input/output device 540 can be interconnected via a system bus 550. The processor 510 is capable of processing instructions (such as the instruction to implement the process 400, 499 or other aspects disclosed herein) for execution within the computing system 500. Such executed instructions can implement one or more components of, for example, the database execution engine. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540. The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces. According to some implementations of the current subject matter, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet). In some implementations of the current subject matter, the computing system 500 can be used to execute various interactive computer software applications that can be used for organization, analysis and/or storage of data in various formats. Alternatively, the computing system 500 can be used to execute any type of software applications. These applications can be used to perform various functionalities, e.g., planning functionalities, computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

FIG. 5B depicts an example implementation of the system 100 (of FIG. 1). The system 100 may be implemented using various physical resources 880, such as at least one or more hardware servers, at least one storage, at least one memory, at least one network interface, and the like. The system 100 may also be implemented using infrastructure, as noted above, which may include at least one operating system 882 for the physical resources 880 and at least one hypervisor 884 (which may create and run at least one virtual machine 886). For example, the audit system 1500, ERP system 1600, and/or other components at FIG. 1 may be run on a corresponding virtual machine 886.

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B; ” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1: A computer-implemented method comprising:
receiving one or more records;
storing the received one or more records in a store further including a plurality of records;
retrieving at least a first record;
checking the first record for a unique identifier, wherein the unique identifier comprises a previous identifier associated with a previous record and a current identifier associated with the first record;
in response to detecting the previous identifier, searching for at least one other record that contains the previous identifier as a current identifier;
in response to the searching indicating a gap, sending a message to a server to provide at least one missing record associated with the gap;
in response to the searching indicating the gap is not present, flagging the first record as audited; and
passing the first record to a first system.

Example 2: The computer-implemented method of Example 1, wherein the one or more records, the plurality of records, the first record, and the other record comprise point-of-service transaction records.

Example 3: The computer-implemented method of any of Examples 1-2, wherein the first system comprises an enterprise resource planning system.

Example 4: The computer-implemented method of any of Examples 1-3, wherein the one or more records are received by an audit system coupled to the first system, and wherein the one or more records are received from a point-of-service device.

Example 5: The computer-implemented method of any of Examples 1-4, wherein the store is located at the audit system, and wherein the store contains the plurality of records that have not been audited by the audit system.

Example 6: The computer-implemented method of any of Examples 1-5, wherein the audit system retrieves the first record from the store.

Example 7: The computer-implemented method of any of Examples 1-6 further comprising: performing a duplicate check for at least the first record by at least searching for another record that contains the current identifier associated with the first record.

Example 8: The computer-implemented method of any of Examples 1-7 further comprising: in response to the searching for the other record that contains the current identifier associated with the first record not detecting any duplication records, flagging first record as audited.

Example 9: The computer-implemented method of any of Examples 1-8, wherein the previous identifier and the current identifier each comprise a 128-bit value configured to provide a universally unique identifier.

Example 10: The computer-implemented method of any of Examples 1-9, wherein the previous identifier and the current identifier each comprise a date, a time, a media-access control (MAC) address, and/or a random value.

Example 11: A system comprising:
at least one processor; and
at least one memory including code which when executed by the at least one processor causes operations comprising:
   receiving one or more records;
   storing the received one or more records in a store further including a plurality of records;
   retrieving at least a first record;
   checking the first record for a unique identifier, wherein the unique identifier comprises a previous identifier associated with a previous record and a current identifier associated with the first record;
   in response to detecting the previous identifier, searching for at least one other record that contains the previous identifier as a current identifier;
   in response to the searching indicating a gap, sending a message to a server to provide at least one missing record associated with the gap;
   in response to the searching indicating the gap is not present, flagging the first record as audited; and
   passing the first record to a first system.

Example 12: The system of Example 11, wherein the one or more records, the plurality of records, the first record, and the other record comprise point-of-service transaction records.

Example 13: The system of any of Examples 11-12, wherein the first system comprises an enterprise resource planning system.

Example 14: The system of any of Examples 11-13, wherein the one or more records are received by an audit system coupled to the first system, and wherein the one or more records are received from a point-of-service device.

Example 15: The system of any of Examples 11-14, wherein the store is located at the audit system, and wherein the store contains the plurality of records that have not been audited by the audit system.

Example 16: The system of any of Examples 11-15, wherein the audit system retrieves the first record from the store.

Example 17: The system of any of Examples 11-16 further comprising:
performing a duplicate check for at least the first record by at least searching for another record that contains the current identifier associated with the first record.

Example 18: The system of any of Examples 11-17 further comprising:
in response to the searching for the other record that contains the current identifier associated with the first record not detecting any duplication records, flagging first record as audited.

Example 19: The system of any of Examples 11-18, wherein the previous identifier and the current identifier each comprise a 128-bit value configured to provide a universally unique identifier.

Example 20: A non-transitory computer-readable storage medium code which when executed by at least one processor causes operations comprising:
receiving one or more records;
storing the received one or more records in a store further including a plurality of records;
retrieving at least a first record;
checking the first record for a unique identifier, wherein the unique identifier comprises a previous identifier associated with a previous record and a current identifier associated with the first record;
in response to detecting the previous identifier, searching for at least one other record that contains the previous identifier as a current identifier;
in response to the searching indicating a gap, sending a message to a server to provide at least one missing record associated with the gap;
in response to the searching indicating the gap is not present, flagging the first record as audited; and
passing the first record to a first system.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed:

1. A computer-implemented method comprising:
receiving one or more records;
storing the received one or more records in a store further including a plurality of records;
retrieving at least a first record;
checking the first record for a unique identifier, wherein the unique identifier comprises a previous identifier associated with a previous record and a current identifier associated with the first record;
in response to detecting the previous identifier, searching for at least one other record that contains the previous identifier as a current identifier;
in response to the searching indicating a gap, sending a message to a server to provide at least one missing record associated with the gap;
in response to the searching indicating the gap is not present, flagging the first record as audited; and
passing the first record to a first system.

2. The computer-implemented method of claim 1, wherein the one or more records, the plurality of records, the first record, and the other record comprise point-of-service transaction records.

3. The computer-implemented method of claim 1, wherein the first system comprises an enterprise resource planning system.

4. The computer-implemented method of claim 1, wherein the one or more records are received by an audit system coupled to the first system, and wherein the one or more records are received from a point-of-service device.

5. The computer-implemented method of claim 4, wherein the store is located at the audit system, and wherein the store contains the plurality of records that have not been audited by the audit system.

6. The computer-implemented method of claim 4, wherein the audit system retrieves the first record from the store.

7. The computer-implemented method of claim 1 further comprising:
performing a duplicate check for at least the first record by at least searching for another record that contains the current identifier associated with the first record.

8. The computer-implemented method of claim 7 further comprising:
in response to the searching for the other record that contains the current identifier associated with the first record not detecting any duplication records, flagging first record as audited.

9. The computer-implemented method of claim 1, wherein the previous identifier and the current identifier each comprise a 128-bit value configured to provide a universally unique identifier.

10. The computer-implemented method of claim 1, wherein the previous identifier and the current identifier each comprise a date, a time, a media-access control (MAC) address, and/or a random value.

11. A system comprising:
at least one processor; and
at least one memory including code which when executed by the at least one processor causes operations comprising:
receiving one or more records;
storing the received one or more records in a store further including a plurality of records;
retrieving at least a first record;
checking the first record for a unique identifier, wherein the unique identifier comprises a previous identifier associated with a previous record and a current identifier associated with the first record;
in response to detecting the previous identifier, searching for at least one other record that contains the previous identifier as a current identifier;
in response to the searching indicating a gap, sending a message to a server to provide at least one missing record associated with the gap;
in response to the searching indicating the gap is not present, flagging the first record as audited; and
passing the first record to a first system.

12. The system of claim 11, wherein the one or more records, the plurality of records, the first record, and the other record comprise point-of-service transaction records.

13. The system of claim 11, wherein the first system comprises an enterprise resource planning system.

14. The system of claim 11, wherein the one or more records are received by an audit system coupled to the first system, and wherein the one or more records are received from a point-of-service device.

15. The system of claim 14, wherein the store is located at the audit system, and wherein the store contains the plurality of records that have not been audited by the audit system.

16. The system of claim 14, wherein the audit system retrieves the first record from the store.

17. The system of claim 11 further comprising:
performing a duplicate check for at least the first record by at least searching for another record that contains the current identifier associated with the first record.

18. The system of claim 17 further comprising:
in response to the searching for the other record that contains the current identifier associated with the first record not detecting any duplication records, flagging first record as audited.

19. The system of claim 11, wherein the previous identifier and the current identifier each comprise a 128-bit value configured to provide a universally unique identifier.

20. A non-transitory computer-readable storage medium code which when executed by at least one processor causes operations comprising:
receiving one or more records;
storing the received one or more records in a store further including a plurality of records;
retrieving at least a first record;
checking the first record for a unique identifier, wherein the unique identifier comprises a previous identifier associated with a previous record and a current identifier associated with the first record;
in response to detecting the previous identifier, searching for at least one other record that contains the previous identifier as a current identifier;
in response to the searching indicating a gap, sending a message to a server to provide at least one missing record associated with the gap;
in response to the searching indicating the gap is not present, flagging the first record as audited; and
passing the first record to a first system.
